(19) United States
(12) Patent Application Publication
(10) Pub. No.: US 2024/0237569 A1
(43) Pub. Date: Jul. 18, 2024

(54) GROWTH INFORMATION PROVIDING APPARATUS, GROWTH INFORMATION PROVIDING METHOD, AND STORAGE MEDIUM

(71) Applicant: NEC Corporation, Tokyo (JP)

(72) Inventors: Yusuke Kikuchi, Tokyo (JP); Kousuke Ishida, Tokyo (JP)

(73) Assignee: NEC Corporation, Tokyo (JP)

(21) Appl. No.: 18/400,160

(22) Filed: Dec. 29, 2023

(30) Foreign Application Priority Data
Jan. 18, 2023 (JP) 2023-006127

(51) Int. Cl. A01B 79/00; G01W 1/02

(52) U.S. Cl. CPC A01B 79/005; G01W 1/02

(57) ABSTRACT

An actual measurement value calculation unit of a growth information providing apparatus calculates an actual measurement value representing a growth situation of a crop in a farm field. An acquisition unit acquires weather information in the farm field where the crop is planted. A trial calculation unit calculates a trial calculation growth curve representing the transition of the growth situation in calculation by making a trial calculation of the transition of the growth situation of the crop toward the target yield using the environment information including the weather information after the crop is planted in the farm field and the information about the target yield of the crop. A display control unit performs display control of displaying both the actual measurement value of the growth situation of the crop and the trial calculation growth curve.

This application is based upon and claims the benefit of priority from Japanese Patent Application No. 2023-006127, filed on Jan. 18, 2023, the disclosure of which is incorporated herein in its entirety by reference.

### TECHNICAL FIELD

The present disclosure relates to a technique for providing information about a growth situation of a crop in a farm field.

### BACKGROUND ART

In agriculture, a vegetation index indicating a degree of growth of a crop may be used to grasp a growth situation of the crop in a farm field. For example, in Reference Document 1 (JP 2017-35055 A), a normalized difference vegetation index (NDVI), a ratio vegetation index (RVI), a difference vegetation index (DVI), and the like are cited as vegetation indices. These vegetation indices are calculated using electromagnetic wave data in a specific wavelength band acquired from a sensor mounted on an artificial satellite, an aircraft, a drone, or the like.

JP 2017-35055 A discloses a technique for estimating a vegetation index that cannot be calculated because the vegetation index based on data of an artificial satellite cannot be calculated in a case where the artificial satellite cannot acquire information about a farm field due to bad weather. That is, in JP 2017-35055 A, the vegetation index related to the farm field when the data of the artificial satellite cannot be acquired is estimated using the relationship (ideal curve) between the month and day and the nitrogen content (in other words, an NDVI) calculated based on the past data and the vegetation index based on the data of the artificial satellite acquired at the past time (for example, 10 days ago). Reference Document 2 (WO 2019/044663 A1) discloses a technique in which an estimated production amount of a crop is calculated using a vegetation index based on sensing data obtained from an artificial satellite or a drone, and each response process is executed depending on whether the estimated production amount is below or above the scheduled production request amount.

### SUMMARY

A main object of the present disclosure is to provide a technique that facilitates grasping of a growth situation of a crop.

In an aspect of a growth information providing apparatus according to the present disclosure, the growth information providing apparatus includes a memory configured to store instructions, and a processor configured to execute the instructions to calculate an actual measurement value representing a growth situation of a crop in a farm field, acquire weather information in the farm field in which the crop is planted, calculate a trial growth curve representing a transition of a growth situation in calculation by making a trial calculation of a transition of a growth situation of the crop toward a target yield using environment information including weather information after planting the crop in the farm field and information about the target yield of the crop, and perform display control of displaying both the actual measurement value of the growth situation of the crop and the trial growth curve.

In an aspect of a growth information providing method executed by a computer according to the present disclosure, the method includes calculating an actual measurement value representing a growth situation of a crop in a farm field, acquiring weather information in the farm field in which the crop is planted, calculating a trial growth curve representing a transition of a growth situation in calculation by making a trial calculation of a transition of a growth situation of the crop toward a target yield using environment information including weather information after planting the crop in the farm field and information about the target yield of the crop, and displaying both the actual measurement value of the growth situation of the crop and the trial growth curve.

In an aspect of a non-transitory computer readable storage medium that stores a computer program according to the present disclosure, the computer program causes a computer to execute the steps of calculating an actual measurement value representing a growth situation of a crop in a farm field, acquiring weather information in the farm field in which the crop is planted, calculating a trial growth curve representing a transition of a growth situation in calculation by making a trial calculation of a transition of a growth situation of the crop toward a target yield using environment information including weather information after planting the crop in the farm field and information about the target yield of the crop, and displaying both the actual measurement value of the growth situation of the crop and the trial growth curve.

### BRIEF DESCRIPTION OF THE DRAWINGS

Exemplary features and advantages of the present invention will become apparent from the following detailed description when taken with the accompanying drawings in which:

FIG. 1 is a diagram describing a configuration of an example embodiment of a growth information providing apparatus according to the present disclosure;

FIG. 2 is a diagram describing a trial calculation growth curve;

FIG. 3 is a diagram illustrating an example of a display mode in which an actual measurement value (actual measurement curve) and a trial calculation growth curve (trial calculation curve) are displayed together;

FIG. 4 is a diagram illustrating an example of a display mode in which the growth situation of the crop in each of a plurality of division regions is displayed;

FIG. 5 is a diagram illustrating an example of a display mode of the transition of a soil moisture index;

FIG. 6 is a flowchart for explaining an example of an operation of the growth information providing apparatus according to the first example embodiment;

FIG. 7 is a diagram describing a modification of the first example embodiment;

FIG. 8 is a diagram describing another modification of the first example embodiment;

FIG. 9 is a diagram describing still another modification of the first example embodiment;

FIG. 10 is a diagram illustrating an example of an actual measurement curve related to an NDVI;

FIG. 11 is a diagram used in the description of the second example embodiment;

FIG. 12 is a diagram used in the description of the second example embodiment;

FIG. 13 is a diagram illustrating an example of the handling reference information;

FIG. 14 is a diagram illustrating another example of the handling reference information;

FIG. 15 is a diagram describing a configuration of another example embodiment of the growth information providing apparatus according to the present disclosure; and

FIG. 16 is a flowchart describing an example of the operation of the growth information providing apparatus illustrated in FIG. 15.

### EXAMPLE EMBODIMENT

The vegetation indices as shown in Reference Document 1 (JP 2017-35055 A) and Reference Document 2 (WO 2019/044663 A1) can represent the growth situation of the crop. In a case where the past vegetation index data in the cultivation period in which the crop was cultivated in the past is accumulated, for example, the average value of the accumulated past vegetation index data can be calculated as the reference data. However, even with such reference data, it is not possible to objectively determine whether the current crop growth situation is successful or delayed from the expected value. That is, weather conditions such as a temperature, a solar radiation amount, and a rainfall amount are greatly involved in the growth of the crop, and the weather conditions vary depending on a cultivation period (season/year) in which the crop is cultivated, so that an expected growth speed also varies. For this reason, even when the reference data that is the average value of the accumulated past vegetation index data and the current growth situation are known, it is difficult for the crop producer or the farm field administrator (hereinafter, the crop producer and the farm field administrator are collectively referred to as a farm field interested party) cultivating the crop to determine whether the current growth situation of the crop is actually delayed or successful.

Therefore, in the example embodiment described below, a technique for easily grasping the growth situation of the crop is proposed.

### First Example Embodiment

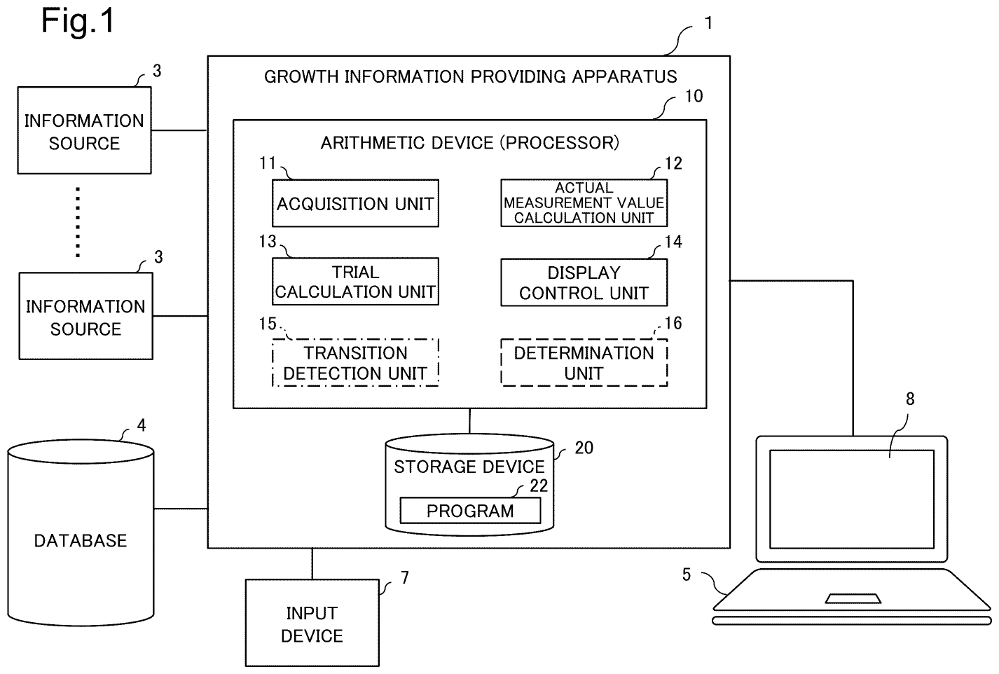

A growth information providing apparatus 1 of the first example embodiment is an apparatus having a configuration as illustrated in FIG. 1 and providing information about a growth situation of a crop in a farm field. The growth information providing apparatus 1 is connected to an information source 3, a database 4, a terminal device 5, and an input device 7.

The information source 3 is an information source that outputs information used by the growth information providing apparatus 1. The number of information sources 3 to which the growth information providing apparatus 1 is connected is not limited to one, and the growth information providing apparatus 1 is connected to a plurality of information sources 3 as necessary. In the first example embodiment, one of the information sources 3 is an information source that outputs a satellite image of a farm field to which information is to be provided. The satellite image of the farm field is a captured image in which the farm field is imaged by an imaging device mounted on an artificial satellite. In the first example embodiment, a vegetation index such as an NDVI, an RVI, or a DVI is used as the information indicating the growth situation of the crop. These indices are indices obtained by quantifying the growth situation (vegetation situation) of the crop from the captured image of the crop using the characteristic of the light reflection for the crop. For example, the calculation expression for calculating the NDVI is the following Expression (1).

$$N D V I = ( N I R - R ) / ( N I R + R ) \qquad ( 1 )$$

where NIR in Expression (1) represents the reflectance in the near-infrared region acquired from the captured image, and R represents the reflectance in the visible red region acquired from the captured image. The NDVI can also be said to be an index representing the growth situation of the leave of the crop, and is represented within a range of a numerical value of −1 to +1, and as the numerical value approaches 1, it indicates that the leaves are growing vigorously.

In the first example embodiment, since the vegetation index using the characteristic of the light reflection for the crop is used, the satellite image of the farm field output by one of the information sources 3 is the satellite image of the farm field including the information about the light having the wavelength used for calculating the vegetation index.

Another one of the information sources 3 is an information source that outputs weather information about a region including the farm field to which information is to be provided. Even different information sources will be described with the same reference numerals.

The input device 7 is a device for which an operator (hereinafter, also referred to as a device operator) inputs information to the growth information providing apparatus 1, and includes a keyboard, a mouse, and the like. The database 4 is a storage device, and the database 4 stores information acquired from the information source 3, information input by the input device 7, data calculated by the growth information providing apparatus 1, and the like.

The terminal device 5 is a computer device operated by a user who is a farm field interested party (a farm field administrator, a crop producer, or the like). The terminal device 5 has a communication function and a display control function of causing a display device 8 to display information. As long as the terminal device 5 is an information device having a communication function and a display control function, its type is not limited, and specific examples thereof include a personal computer, a tablet, and a smartphone. In a case where the terminal device 5 is a smartphone or a tablet, the display device 8 is integrated with the terminal device 5, but in a case where the terminal device 5 is a personal computer, the display device 8 may be externally attached. The connection between the terminal device 5 and the growth information providing apparatus 1 is executed by an application program (app) for causing the terminal device 5 to have a function of cooperating with the growth information providing apparatus 1. Alternatively, the connection between the terminal device 5 and the growth information providing apparatus 1 may be executed by a browser (software for browsing information about the Internet). Whether the connection between the terminal device 5 and the growth information providing apparatus 1 is executed by the application or the browser is appropriately set by a system designer or the like, and is not limited here. In the example of FIG. 1, one terminal device 5 is connected to the growth information providing apparatus 1, but the growth information providing apparatus 1 can be connected to a plurality of terminal devices 5.

The growth information providing apparatus 1 is a computer device, and includes an arithmetic device 10 and a storage device 20. The storage device 20 includes a storage medium that stores data and a computer program (hereinafter, also referred to as a program) 22. There is a plurality of types of storage devices, and a computer device may include a plurality of types of storage devices. The type and the number of storage devices provided in the growth information providing apparatus 1 are not limited, and the description thereof will be omitted.

The arithmetic device 10 includes a processor such as a central processing unit (CPU) and a graphics processing unit (GPU), and can have various functions based on the program 22 by reading and executing the program 22 stored in the storage device 20. In the first example embodiment, the arithmetic device 10 includes an acquisition unit 11 indicated by a solid line in FIG. 1, an actual measurement value calculation unit 12, a trial calculation unit 13, and a display control unit 14 as functional units that provide information about the growth situation of the crop.

The acquisition unit 11 acquires information from the information source 3. In the first example embodiment, the information acquired by the acquisition unit 11 from the information source 3 is a predetermined type of information including a satellite image of the farm field and weather information about the farm field. The period and timing when the acquisition unit 11 acquires the information are set by a device designer or the like according to the use of the information for each type of the information. For example, regarding the satellite image of the farm field, the acquisition timing is set in such a way that the satellite image of the farm field is acquired from the information source 3 once a day in a designated time zone. The imaging time when the farm field is imaged by the artificial satellite is determined for each region (that is, since the artificial satellite orbits around the earth at a constant cycle, the farm field is imaged at the same time). For this reason, the imaging frequency and the imaging time are determined by the passing time and the number of return days when the artificial satellite passes over the farm field. In consideration of the above, the timing at which the acquisition unit 11 acquires the satellite image from the information source 3 that outputs the satellite image of the farm field is set.

The acquisition period of the satellite image of the farm field is set to be from one month before the scheduled planting date on which the crop is planted to three days after the harvest completion date of the crop through the cultivation period of the crop. Furthermore, here, the acquisition unit 11 acquires weather information in the farm field in which the crop is planted. The weather information acquired by the acquisition unit 11 is, for example, daily weather information, and is weather information including a solar radiation amount, a temperature, a relative humidity, a rainfall amount, and a wind speed in a region including the farm field. The acquisition unit 11 may also acquire information about a weather forecast.

The information acquired by the acquisition unit 11 is stored in the storage device 20 and the database 4 in association with, for example, acquisition date information. In a case where there is a plurality of farm fields to which information is to be provided, the information acquired by the acquisition unit 11 is further stored in the storage device 20 and the database 4 in association with identification information about the farm field related to the information.

The actual measurement value calculation unit 12 calculates an actual measurement value representing the growth situation of the crop in the farm field. In the first example embodiment, as described above, the vegetation index is calculated using the satellite image of the farm field as the actual measurement value indicating the growth situation of the crop. It is assumed that the NDVI that is a vegetation index is calculated as an actual measurement value of the crop growth situation. The timing at which the actual measurement value calculation unit 12 calculates the actual measurement value is set by a device designer or the like in consideration of the acquisition timing of the satellite image of the farm field and the like, and is not limited. For example, in a case where the acquisition unit 11 acquires the satellite image of the farm field once a day, the calculation operation by the actual measurement value calculation unit 12 is executed when the acquisition unit 11 acquires the satellite image of the farm field as a trigger. There is a case where the farm field is divided into a plurality of regions, and the monitoring of the crop growth situation and the irrigation control are performed for each division region. In this case, the actual measurement value of the growth situation of the crop is calculated for each division region of the farm field.

The information (data) on the actual measurement value calculated by the actual measurement value calculation unit 12 is stored in the storage device 20 and the database 4 in association with information about the imaging date and time of the satellite image used to calculate the actual measurement value (NDVI), weather information about the farm field at the imaging time point, farm field identification information, division region identification information about the farm field, and the like.

The trial calculation unit 13 calculates a trial calculation growth curve representing the transition of the growth situation in calculation by making a trial calculation of the transition of the growth situation of the crop toward the target yield using the environment information including the weather information after the crop is planted in the farm field, the information about the target yield of the crop, and the crop variety information. The environment information is information indicating the surrounding environment of the crop related to the growth of the crop planted in the farm field, and in the first example embodiment, the environment information includes the soil property (sand quality, clay quality, and the like) of the soil of the farm field and weather information. The weather information includes information about a temperature, a solar radiation amount, a relative humidity, a rainfall amount, and a wind speed.

Since it is assumed that the crop growth situation of which the trial calculation unit 13 makes a trial calculation is compared with the actual measurement value calculated by the actual measurement value calculation unit 12, the crop growth situation is represented by the same index as the actual measurement value calculated by the actual measurement value calculation unit 12. That is, in the first example embodiment, the trial calculation unit 13 makes a trial calculation of how the NDVI related to the crop planted in the farm field transitions in calculation in the environment indicated in the actually acquired environment information.

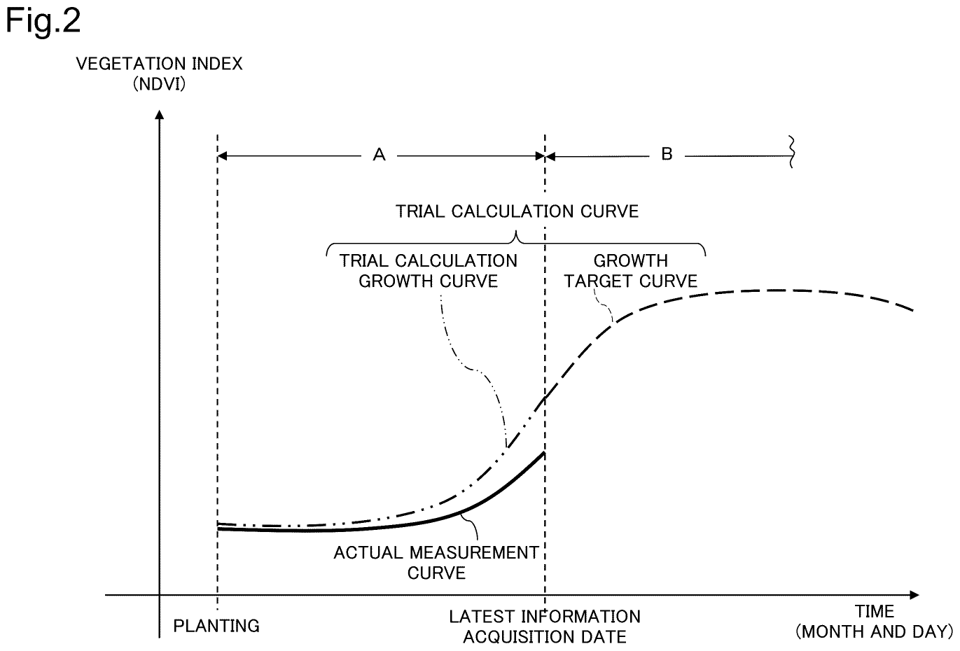

The trial calculation growth curve is data representing a transition of a growth situation in calculation representing how a crop grows toward a target yield in an environment where the crop has actually grown. Since this trial calculation growth curve is a curve calculated using actual weather information, the trial calculation growth curve is a curve representing the transition of the growth situation in calculation in a period A from when the crop was planted in the farm field to the latest information acquisition date when the weather information was acquired, as represented by a chain line in FIG. 2. The actual measurement curve indicated by a solid line in FIG. 2 is a curve representing the transition of the actual measurement value calculated by the actual measurement value calculation unit 12. In the example of FIG. 2, the trial calculation growth curve and the actual measurement curve represent the transition of the growth situation of the crop with the time of planting (planting) as a starting point. However, the starting point of the trial calculation growth curve and the actual measurement curve is not limited to the time of planting, and are set by a device designer or the like, for example.

As an example of a method by which the trial calculation unit 13 calculates a trial calculation growth curve, there is a calculation method using the following regression analysis. That is, a regression equation by regression analysis using the actual measurement value of the growth situation and the environment information in the cultivation period of the crop in the past (previous year, two years before, etc.) is calculated in advance. The objective variable in the regression equation is the value (NDVI) of the index indicating the growth situation of the crop. Specific examples of the explanatory variables of the regression equation include the number of elapsed days after planting, the type of crop, the variety of crop, the soil property of soil, the integrated temperature, the integrated amount of solar radiation, the relative humidity, the rainfall amount, the wind speed, and the target yield.

Further, in the first example embodiment, the trial calculation unit 13 calculates a growth target curve as indicated by a dotted line in FIG. 2. The growth target curve here is a curve following the trial calculation growth curve based on the trial calculation as described above, and is a curve representing what growth situation the crop should be in toward the target yield in the future after the latest information acquisition date when the weather information was acquired. Since the growth target curve relates to a future period B after the latest information acquisition date, for example, a common year value of weather information in a period related to the period B is used as reference weather information instead of actual weather information in calculating the growth target curve. For example, the trial calculation unit 13 calculates the growth target curve by regression analysis using the environment information including such reference weather information and the target yield as in the calculation of the trial calculation growth curve. In the following description, a curve obtained by combining the trial calculation growth curve and the growth target curve is also referred to as a trial calculation curve.

As described above, in a case where the farm field is divided into a plurality of regions and the monitoring of the crop growth situation and the irrigation control are performed for each of the division regions, a trial calculation curve (trial calculation growth curve and growth target curve) is calculated for each of the division regions.

Information (data) of the trial calculation curve (trial calculation growth curve and growth target curve) calculated by the trial calculation unit 13 is stored in the storage device 20 and the database 4 in association with information such as environment information used for the calculation, farm field identification information, and division region identification information about the farm field.

The display control unit 14 cooperates with the terminal device 5 to control screen display of the display device 8 related to the terminal device 5. For example, in a case where the display of the crop growth situation is requested by the farm field interested party by the operation of the terminal device 5 by the farm field interested party (user), the display control unit 14 receives the request of the display (display request) via the terminal device 5. The display request is associated with, for example, farm field identification information for identifying the farm field to which information is to be provided. The display control unit 14 outputs (replies) the information about the growth situation of the crop in the farm field related to the received display request to the terminal device 5 as a request source. By the display control operation of the terminal device 5 that has received the information, the information about the crop growth situation output by the display control unit 14 is displayed on the screen of the display device 8.

In the first example embodiment, as described above, a trial calculation curve is calculated. As a result, in a case where the display of the information about the crop growth situation is requested by the farm field interested party, the display control unit 14 outputs the information about the actual measurement value and the trial calculation curve to the terminal device 5 in order to display the information (data) about the trial calculation curve together with the actual measurement value of the crop growth situation. As a result, the actual measurement value (actual measurement curve) and the trial calculation curve are displayed together on the screen of the display device 8 related to the terminal device 5.

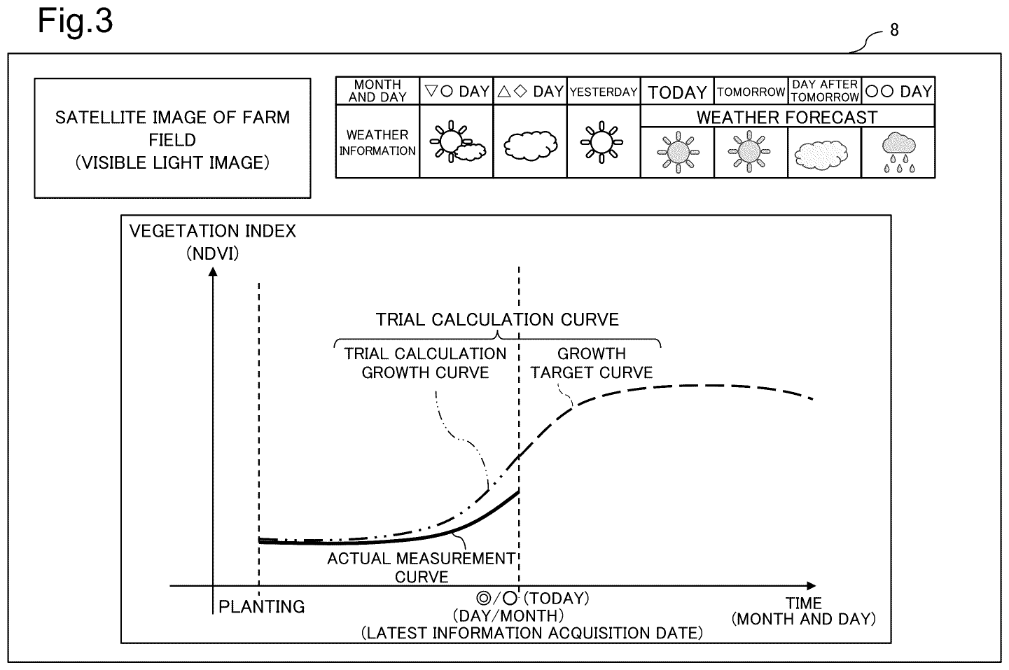

FIG. 3 illustrates an example of screen display related to display of information about the growth situation of the crop on the display device 8. In the example of FIG. 3, a trial calculation growth curve of which a trial calculation is made using environment information including weather information and the target yield from the time of the planting to the latest information acquisition date is displayed on the same graph together with an actual measurement curve based on the actual measurement value. In the example of FIG. 3, a captured image (satellite image) obtained by capturing an image of the farm field with visible light is also displayed on the display device 8 together with information indicating the growth situation of the crop. Furthermore, in the example of FIG. 3, daily weather information acquired from the information source 3 and a weather forecast for a set number of days after the display time point are illustrated. Not only the weather but also weather information such as a temperature, humidity, a precipitation probability, and a wind speed may be displayed. In this case, the information to be displayed is acquired from the information source 3 by the acquisition unit 11. Furthermore, not only the weather information but also environment information about the farm field including other information about the farm field may be displayed. That is, the display control unit 14 performs display control of displaying the environment information about the farm field.

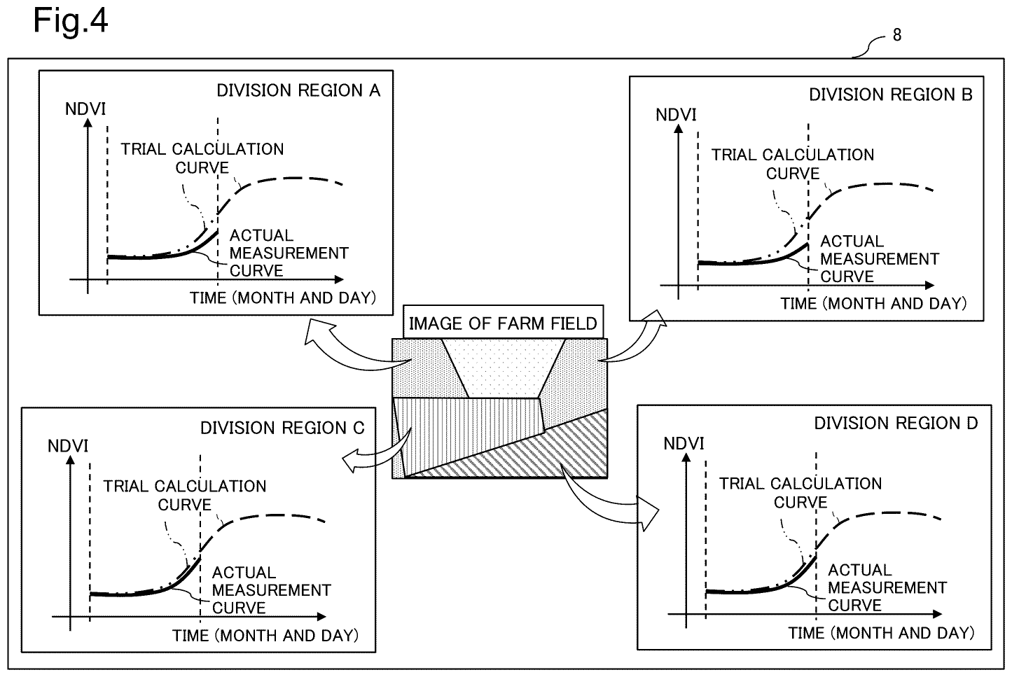

FIG. 4 illustrates another example of the screen display on the display device 8, the screen display indicating the information about the crop growth situation. The example of FIG. 4 is an example of a case where a plurality of division regions is set in the farm field. In the example of FIG. 4, information about the growth situation of the crop of the respective division regions in the farm field is displayed side by side. Also in this example, the actual measurement curve and the trial calculation curve are displayed together as the information about the crop growth situation for each of the division regions. The trial calculation curve here is a trial calculation curve reflecting the target yield for each division region. In the example of FIG. 4, in order to facilitate understanding of the correspondence relationship between the information about the crop growth situation and the position of the division region related to the information, an image (an arrow image in the example of FIG. 4) indicating the correspondence relationship is displayed. As illustrated in FIG. 4, even in a case where information about a plurality of division regions is displayed side by side, weather information in the farm field as illustrated in FIG. 3 may be displayed.

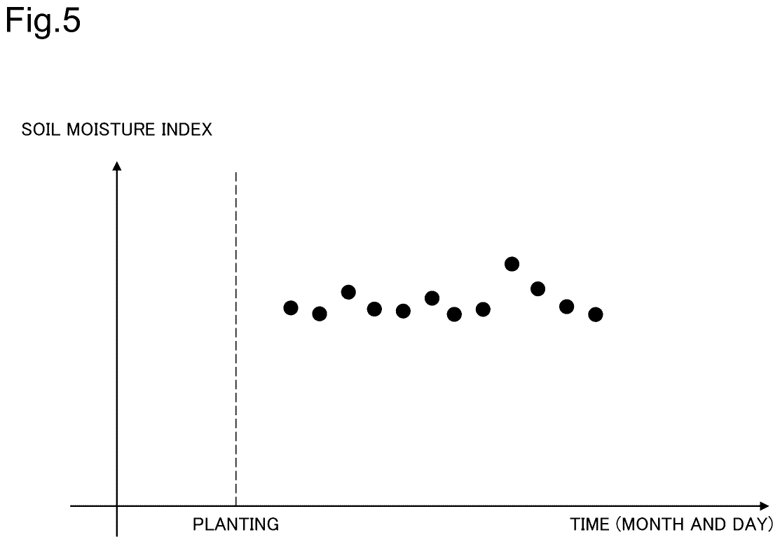

Furthermore, in a case where the soil moisture sensor is installed in the farm field, information about a numerical value (hereinafter, also referred to as a soil moisture index) related to the sensor output value output from the soil moisture sensor may be output from the display control unit 14 to the terminal device 5, and thus, may be displayed on the display device 8. In this case, in the display device 8, the information about the soil moisture index may be displayed on the same screen as the screen representing the information about the growth situation of the crop as illustrated in FIGS. 3 and 4, or may be displayed on another screen. An example of the display mode of the soil moisture index includes a mode of a list or table in which the numerical value of the soil moisture index is displayed in a list in association with the date and time when the sensor value on which the soil moisture index is based is output from the soil moisture sensor. Another example of the display mode of the soil moisture index includes a mode of a graph as illustrated in FIG. 5. In a case where a plurality of soil moisture sensors is installed in the farm field, for example, information about a soil moisture index based on an average value of sensor output values of the plurality of soil moisture sensors in the farm field is displayed on the display device 8. In a case where the division region is set in the farm field, information about the soil moisture index based on the average value of the sensor output values of the plurality of soil moisture sensors for each division region is displayed on the display device 8. In a case where the captured image or the plan view of the farm field is displayed on the same screen of the display device 8 on which the information about the soil moisture index is displayed, the installation position of the soil moisture sensor may be displayed on the captured image or the plan view of the farm field.

In a case where the information about the soil moisture index as described above is output from the display control unit 14 to the terminal device 5, the acquisition unit 11, for example, periodically acquires the information about the sensor output value of the soil moisture sensor from the information source 3 that outputs the sensor output value of the soil moisture sensor.

Furthermore, a pipe for supplying irrigation water is laid in the farm field, and the amount of water supplied from the pipe to the soil may be controlled. In such a case, a flow rate sensor of irrigation water is installed in the pipe. In such a case, information about a numerical value (hereinafter, also referred to as irrigation water amount index) according to the sensor output value of the flow rate sensor may be output from the display control unit 14 to the terminal device 5 and displayed on the display device 8 by the terminal device 5. As for the display of the irrigation water amount index, various display modes can be used as in the display of the soil moisture index described above. Information about the irrigation water amount index is displayed on the display device 8 in a display mode set by a device designer or the like. In a case where such information about the irrigation water amount index is output from the display control unit 14 to the terminal device 5, the acquisition unit 11 acquires information about the sensor output value of the flow rate sensor from the information source 3 that outputs the sensor output value of the flow rate sensor, for example, periodically.

Furthermore, there may be a display device directly connected to the growth information providing apparatus 1 and viewed by a farm field interested party, and a display device directly connected to the growth information providing apparatus 1 and viewed by a device operator of the growth information providing apparatus 1. In this case, the display control unit 14 further performs display control of displaying information such as an actual measurement curve and a trial calculation curve representing the growth situation of the crop, a soil moisture index, and an irrigation water amount index on a screen of a display device directly connected to such the growth information providing apparatus 1. The display mode of the information displayed on the screen of the display device by the display control unit 14 is similar to, for example, the display mode of the display device 8 by the terminal device 5. The display device directly connected to the growth information providing apparatus 1 may be a display device of a tablet terminal. In this case, the display control unit 14 controls display of the display device in cooperation with a control device (processor) of the tablet terminal.

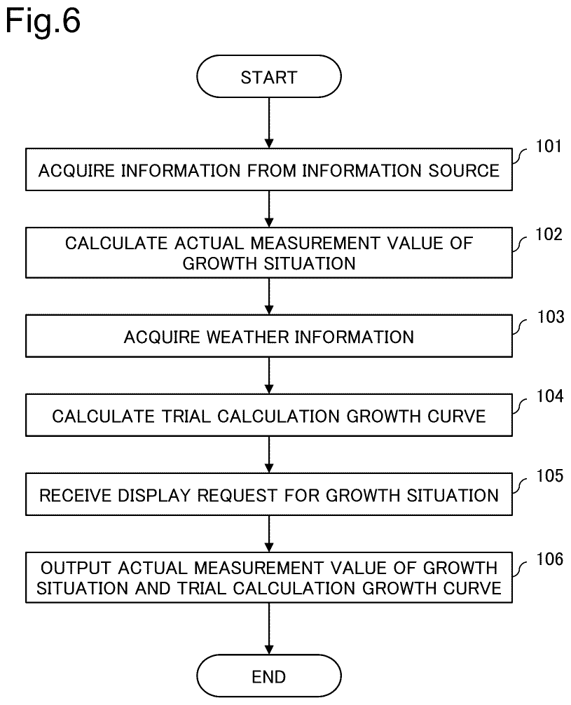

The growth information providing apparatus 1 according to the first example embodiment has the above-described configuration. Next, an example of an operation related to information provision in the growth information providing apparatus 1 according to the first example embodiment will be described with reference to FIG. 6. FIG. 6 is a flowchart describing an example of an operation related to information provision in the growth information providing apparatus 1.

For example, it is assumed that the acquisition unit 11 acquires the satellite image from the information source 3 that outputs the satellite image of the farm field at a frequency of once a day, and acquires the weather information about the farm field from the information source 3 that outputs the weather information. In such a case, when the acquisition unit 11 acquires a satellite image of the farm field as the information from the information source 3 (step 101 in FIG. 6), the actual measurement value calculation unit 12 calculates the NDVI that is an actual measurement value representing the crop growth situation, from the acquired satellite image of the farm field (step 102). When the acquisition unit 11 acquires weather information (step 103), the trial calculation unit 13 calculates a trial calculation growth curve using updated environment information obtained by adding newly acquired weather information to the weather information acquired after planting, and target yield and variety information (step 104). That is, the trial calculation growth curve is updated by reflecting newly acquired weather information. The order of the operations in steps 101 and 102 and the operations in steps 103 and 104 may be reversed. There is a case where there is a cloud above the farm field and the farm field is not clearly shown in the satellite image. In such a case, there is a case where the NDVI cannot be calculated from the satellite image. A handling method for such a case is determined in advance. For example, as a handling method, there are various methods such as estimating the NDVI by a predetermined interpolation method and processing without a value, but the handling method is not limited here, and thus the description thereof will be omitted.

Thereafter, for example, when display of the growth situation of the crop is requested by the terminal device 5 (step 105), the display control unit 14 outputs (returns) the actual measurement value (actual measurement curve) of the growth situation of the crop and the trial calculation growth curve to the terminal device 5 as the request source (step 106). As a result, the actual measurement value (actual measurement curve) of the growth situation of the crop and the trial calculation growth curve are displayed together on the display device 8 by the display control operation of the terminal device 5. That is, it can be said that the display control unit 14 performs display control of displaying the actual measurement value (actual measurement curve) of the crop growth situation and the trial calculation growth curve together on the display device 8 related to the terminal device 5 in cooperation with the terminal device 5.

With the above-described configuration, the growth information providing apparatus 1 according to the first example embodiment can cause the display device 8 related to the terminal device 5 to display both the actual measurement value (actual measurement curve) of the growth situation of the crop and the trial calculation growth curve. Since the trial calculation growth curve is a curve in which a trial calculation is made of the transition of the growth situation of the crop toward the target yield using the information about the weather in which the crop of the farm field has actually grown, it is possible to express the transition of the target growth situation matching the actual situation toward the target yield. Since the actual measurement value (actual measurement curve) of the growth situation of the crop is displayed together with such a trial calculation growth curve (in other words, information is provided to the farm field interested party), the farm field interested party can easily determine whether the growth situation of the crop is actually successful or delayed. That is, the growth information providing apparatus 1 can provide information for determining whether the growth situation of the crop is successful or delayed.

In general, a high value of the vegetation index is expected in the case of cultivating a variety with vigorous vegetation or in the case of aiming at a high harvest amount, and it is determined that there is no problem even if the value of the vegetation index is low in the case of cultivating a variety with less vigorous vegetation or in the case where a low harvest amount is acceptable. That is, the criterion for determining whether the growth situation of the crop is successful or delayed differs depending on the variety of the crop. In consideration of this, the trial calculation unit 13 of the growth information providing apparatus 1 calculates a trial calculation curve serving as a criterion for determining the growth situation of the crop using the target yield and the variety information about the crop. As a result, the trial calculation curve calculated by the trial calculation unit 13 is a trial calculation curve in which the target yield and the variety of the crop are taken into consideration, and is effective information as a criterion for the farm field interested party to objectively determine whether the growth situation is successful or delayed from the expectation.

### First Modification of First Example Embodiment

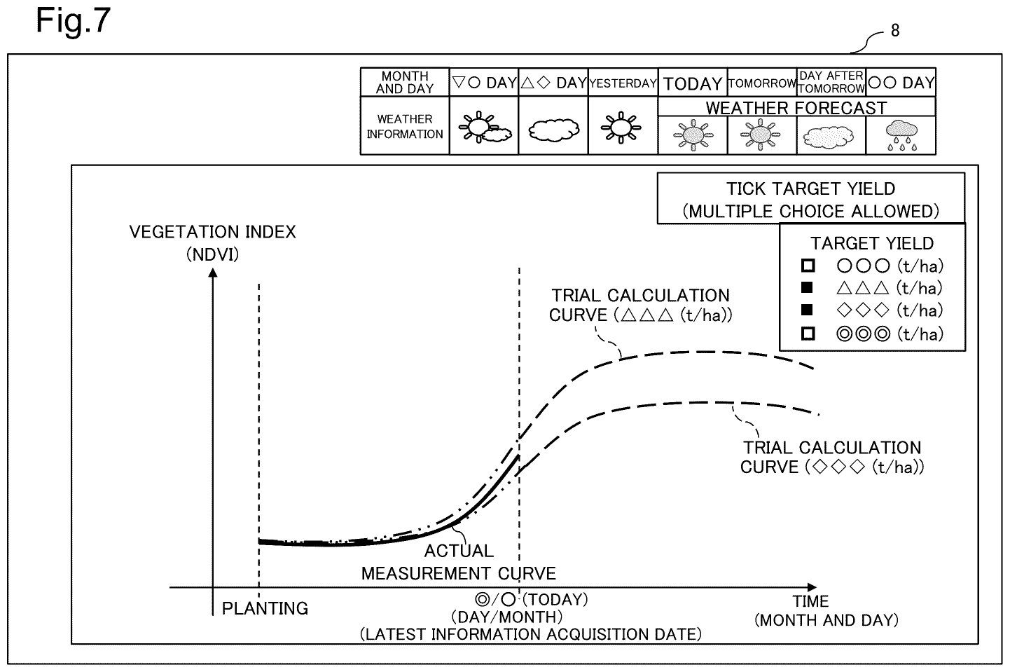

The trial calculation unit 13 calculates a plurality of trial calculation curves (trial calculation growth curve and growth target curve) having different target yields. The display control unit 14 receives a request for displaying a selected trial calculation curve from the terminal device 5 among a plurality of trial calculation curves having different target yields to output information about one or a plurality of trial calculation curves according to the request to the terminal device 5 as a request source. For example, FIG. 7 illustrates an example of screen display of the display device 8 in which information about a plurality of target yields is received and a plurality of trial calculation curves related thereto is displayed.

For example, the farm field interested party may set a plurality of target yields such as a target yield based on a request and a target yield desired to be higher than the requested target yield. In such a case, it is assumed that there is a demand to refer to a trial calculation curve for each of such a plurality of target yields. The growth information providing apparatus 1 having the configuration as described in the first modification can meet such a demand.

### Second Modification of First Example Embodiment

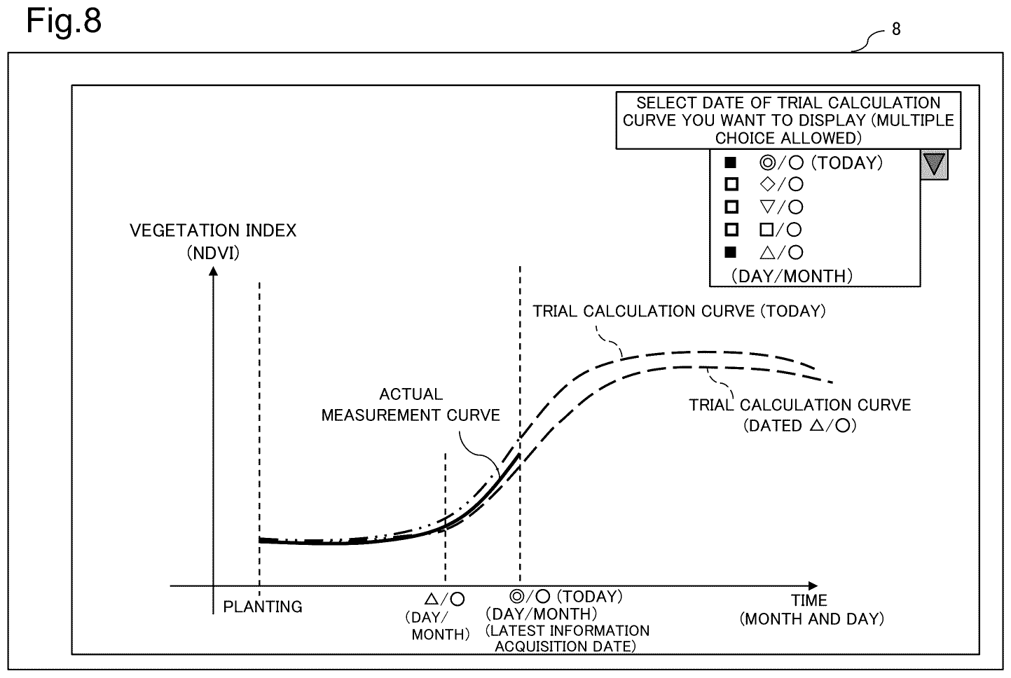

Since the trial calculation is made of the trial calculation growth curve using actual weather information as described above, for example, it is considered that a trial calculation curve including a trial calculation growth curve of which the trial calculation is made three weeks after planting and a trial calculation curve including a trial calculation growth curve of which the trial calculation is made seven weeks after planting are changed. The growth information providing apparatus 1 according to the second modification is configured to display such a change in the trial calculation curve on the display device 8. That is, in the second modification, the display control unit 14 receives, for example, a request for displaying a plurality of trial calculation curves having different trial calculation dates from the terminal device 5 to output information about the plurality of trial calculation curves according to the request to the terminal device 5 as a request source. FIG. 8 illustrates an example of screen display of the display device 8 in which a plurality of trial calculation curves having different trial calculation dates is displayed. In the example of FIG. 8, the screen configuration of the display device 8 is a screen configuration having a function of receiving information about the trial calculation date of the trial calculation curve desired to be displayed.

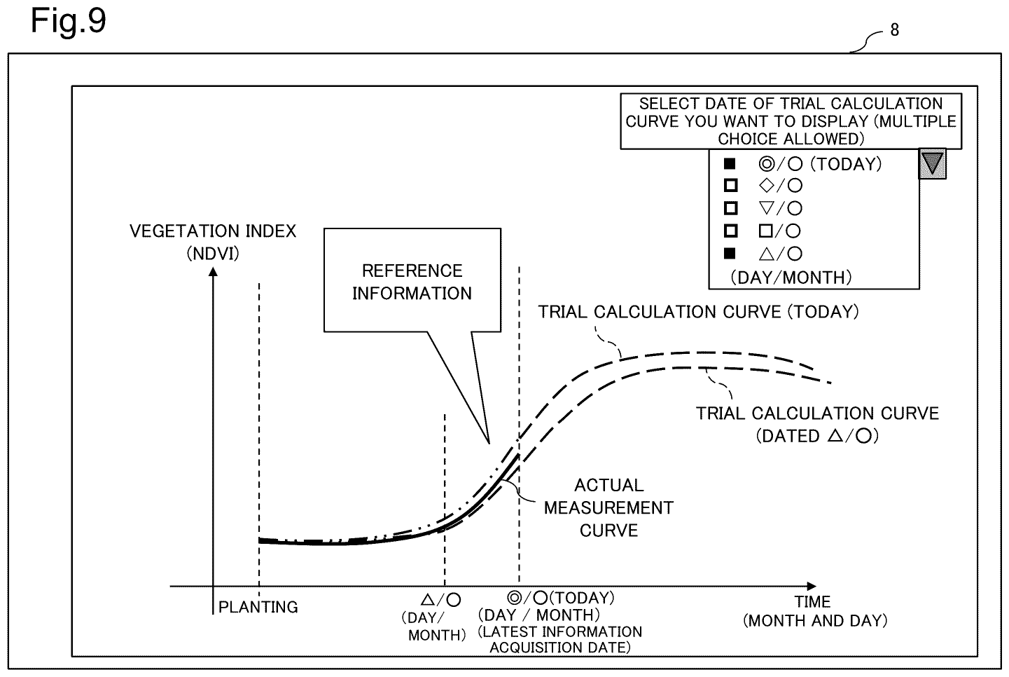

In the case of such a configuration, the growth information providing apparatus 1 may further include the following configuration. For example, the display control unit 14 outputs a plurality of trial calculation curves having different trial calculation dates to the terminal device 5 as the request source in response to the request to output information about work performed in the farm field in the trial calculation day and information about weather as the growth related information. As a result, on the screen of the display device 8, for example, as illustrated in FIG. 9, the growth related information is displayed as the reference information. The type of information output from the display control unit 14 as the growth related information is predetermined, and the display control unit 14 extracts the information from the storage device 20 or the database 4 to output the information. In a case where the information about the fertilization is output from the display control unit 14 as the growth related information, the information about the fertilization is stored in the storage device 20 of the growth information providing apparatus 1 and the database 4 by the device operator or the like using the input device 7, for example.

### Second Example Embodiment

Hereinafter, the second example embodiment according to the present disclosure will be described. In the description of the second example embodiment, the same reference numerals are given to the same name parts as those of the components constituting the growth information providing apparatus of the first example embodiment, and redundant description of the common parts will be omitted.

The growth information providing apparatus 1 of the second example embodiment has a function of providing information about a growth situation in consideration of a growth stage of a crop. That is, the growth stage of the crop is roughly divided into three periods (stages) of a vegetative growth stage, a reproductive growth stage, and a ripening period. The vegetative growth stage refers to a period of a stage from germination of a crop to the start of flowering differentiation. The reproductive growth stage refers to a period of a stage in which a primary group of a flower or an inflorescence is formed at the top of a stem or the like. The ripening period refers to a period of a stage in which seed coat, embryo, and endosperm are formed as seeds after flowering and fertilization of a crop. Examples of the crop harvested in the vegetative growth stage include bean sprouts, spinach, green onion, cabbage, Japanese radishes, and potatoes. Examples of the crop harvested in the reproductive growth stage include broccoli, cucumber, eggplant, green bean, melon, and tomato. Crop cultivation management is performed in consideration of harvest times of such crops. For example, in a crop harvested in the reproductive growth stage, when entering the reproductive growth stage from the vegetative growth stage, cultivation management is performed focusing on, for example, the size and the number of flower buds and the state of the thickness of stem rather than the growth of leaves.

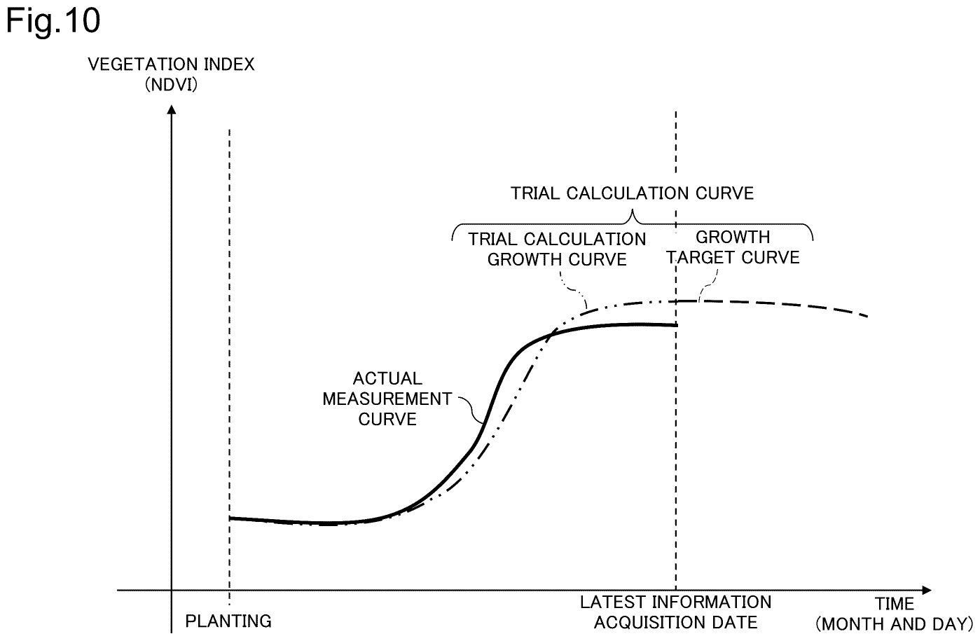

As described above, depending on the type of the crop planted in the farm field, the index of the growth situation of the crop that the farm field interested party wants to know changes depending on the growth stage of the crop. Since the NDVI is an index indicating leaf growth, when the leaf growth of the crop is stable (that is, in the reproductive growth stage), as illustrated in FIG. 10, the NDVI does not show a large change, and thus it is not useful as an index indicating a growth situation. Such a circumstance is also considered to be a factor that the index of the growth situation of the crop desired to be known by the farm field interested party changes depending on the growth stage of the crop.

Therefore, the growth information providing apparatus 1 of the second example embodiment includes a transition detection unit 15 as indicated by a chain line in FIG. 1 in addition to the configuration of the first example embodiment. The transition detection unit 15 detects that the growth stage of the crop has transitioned from the vegetative growth stage to the reproductive growth stage. For example, the transition of the growth stage of the crop can be detected by a change tendency of the NDVI (inclination of an actual measurement curve of the NDVI). For this reason, for example, information for determining the transition of the growth stage of the crop using the change tendency of the NDVI is given in advance to the growth information providing apparatus 1 as the transition determination information. Using the actual measurement curve of the NDVI and the transition determination information, the transition detection unit 15 detects that the growth stage of the crop has transitioned from the vegetative growth stage to the reproductive growth stage.

In the second example embodiment, it is assumed that a means capable of acquiring a captured image in which flower buds and stems of the crop in a farm field are imaged, for example, periodically (for example, once a day) is provided. For example, a fixed point camera for imaging flower buds and stems of the crop is installed in a farm field, or flower buds and stems of the crop are periodically imaged by an imaging device mounted on an unmanned aerial vehicle such as a drone. The acquisition unit 11 acquires a captured image of a flower bud or a stem of a crop from the information source 3 that outputs the captured image of the fixed point camera or the captured image by the unmanned aerial vehicle.

Further, in the second example embodiment, the actual measurement value calculation unit 12 calculates the number of flower buds per unit area determined in advance, the size (average value) of the flower buds, and the thickness (average value) of the stem, for example, as the actual measurement value of the index indicating the growth situation of the crop by analyzing the captured image of the flower buds and the stems of the crop in addition to the calculation of the NDVI. The information (data) of the actual measurement value regarding the flower buds and the stems calculated by the actual measurement value calculation unit 12 is stored in the storage device 20 and the database 4 in association with information about the imaging date and time of the captured image used to calculate the actual measurement value, weather information about the farm field at the imaging time point, farm field identification information, division region identification information about the farm field, and the like.

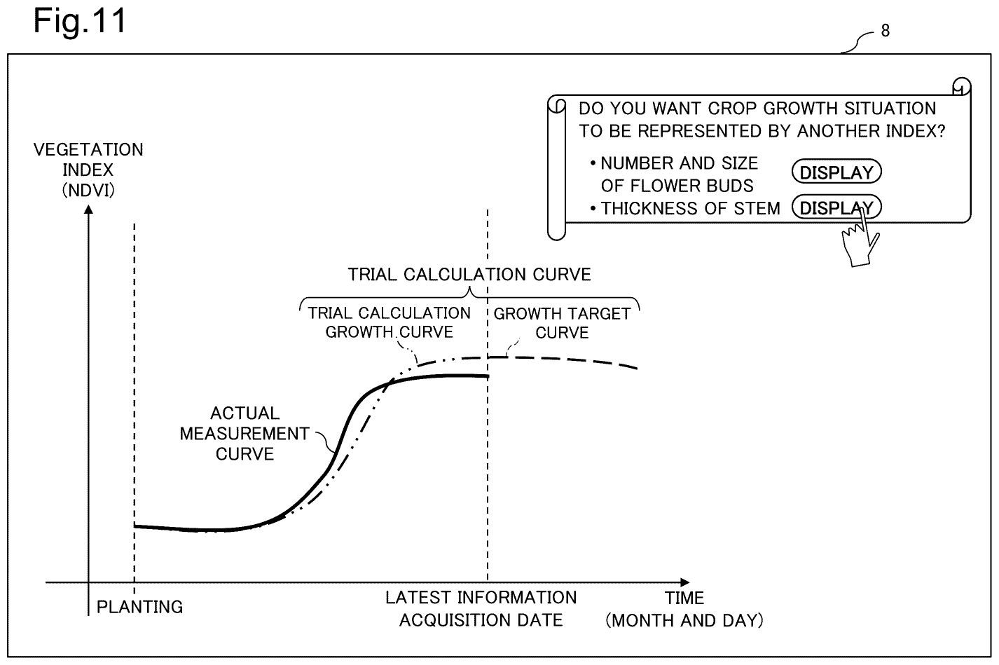

Furthermore, in the second example embodiment, when the transition detection unit 15 detects that the growth stage of the crop has transitioned, the display control unit 14 outputs, to the terminal device 5, display information inquiring about a change in an index indicating the growth situation of the crop as illustrated in FIG. 11, for example. As a result, such display is performed on the display device 8 of the terminal device 5. In the example of FIG. 11, the display includes link information for connecting to information about the number and the size of flower buds, which is an index indicating the growth situation of the crop, and link information for connecting to information about the thickness of the stem. Therefore, information about the number and the size of the flower buds and information about the thickness of the stem which are indices indicating the growth situation of the crop, are read from the storage device 20 or the database 4 based on the operation of the farm field interested party, and are output to the terminal device 5 by the display control unit 14. As a result, for example, an actual measurement value indicating the growth situation of the crop is displayed on the display device 8 according to the terminal device 5 with a transition from a screen on which the NDVI is displayed transitions to another screen on which information about the number and the size of flower buds and information about the thickness of stem, which are other indices, are displayed.

The growth information providing apparatus 1 of the second example embodiment has the above-described configuration. Therefore, the growth information providing apparatus 1 according to the second example embodiment can provide the actual measurement values of the plurality of indices related to the growth stage of the crop as the actual measurement value indicating the growth situation of the crop to the farm field interested party, and can improve convenience.

As described above, in the case of calculating the actual measurement values of the plurality of indices representing the growth situation of the crop, the trial calculation unit 13 may calculate a trial calculation curve by, for example, regression analysis for each of the indices, and the information about the trial calculation curve may be output to the terminal device 5 by the display control unit 14. As a result, even in a case where the actual measurement value of not only the NDVI but also another index indicating the growth situation is displayed on the display device 8, it is possible to perform display control in such a way as to display information about the related trial calculation curve on the display device 8 together with the actual measurement value.

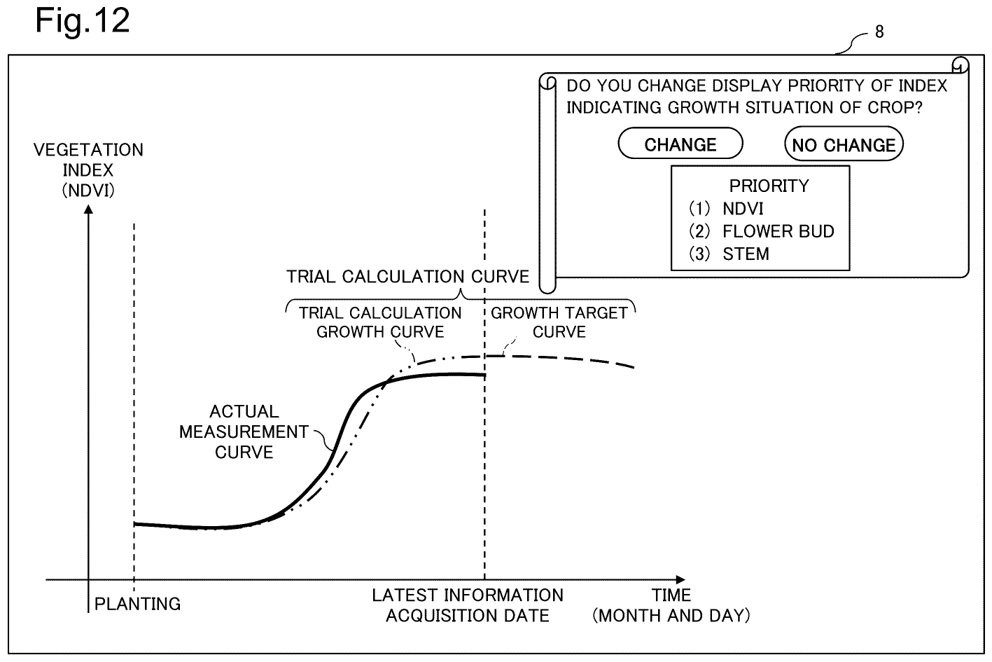

Furthermore, in a case where actual measurement values of a plurality of indices representing the crop growth situation are calculated, in a case where there is one index to be displayed on the screen representing the crop growth situation, the display priority of the index is set. In such a case, the growth information providing apparatus 1 may be provided with a configuration capable of changing the display priority of the index. For example, using a screen as illustrated in FIG. 12, the growth information providing apparatus 1 receives a change in the display priority of an index indicating the growth situation of a crop, and the growth information providing apparatus 1 changes the setting of the display priority of the index.

### Third Example Embodiment

Hereinafter, the third example embodiment according to the present disclosure will be described. In the description of the third example embodiment, the same reference numerals are given to the same components as those of the growth information providing apparatus of the first and second example embodiments, and redundant description of the common parts will be omitted.

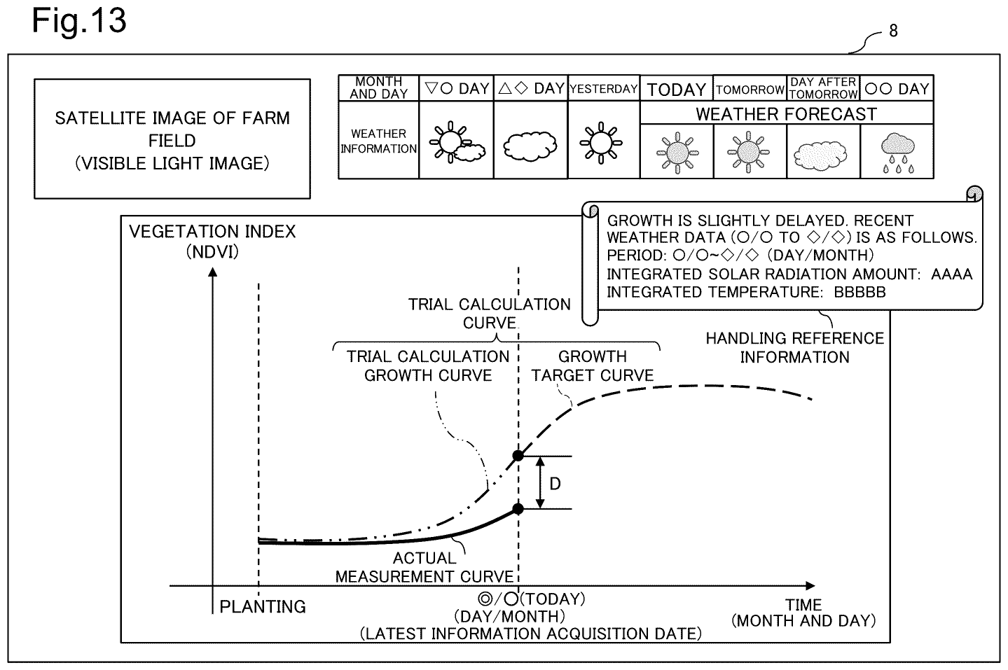

The growth information providing apparatus 1 according to the third example embodiment has a configuration for providing information (handling reference information) that serves as a reference to handle the delay in a case where the growth of the crop in a farm field is delayed. That is, the growth information providing apparatus 1 according to the third example embodiment includes a determination unit 16 as indicated by a dotted line in FIG. 1 in addition to the configuration of the first or second example embodiment. The determination unit 16 determines whether the growth of the crop is delayed using the actual measurement value of the growth situation of the crop and the trial calculation growth curve (trial calculation curve). For example, the determination unit 16 compares the actual measurement value of the growth situation of the crop with the trial calculation growth curve (trial calculation curve), and determines whether the actual measurement value deviates to the lower side with respect to the trial calculation growth curve as illustrated in FIG. 13, and an amount of deviation D is equal to or more than a threshold value. The threshold value is an amount of deviation of an actual measurement value from a trial calculation growth curve for determining whether the growth of the crop is delayed, and is set in advance in consideration of the type of the crop, the state of the soil of the farm field, and the like.

In a case where the actual measurement value deviates to the lower side with respect to the trial calculation growth curve and the amount of deviation D is equal to or more than the threshold value, the determination unit 16 determines that the growth of the crop is delayed. The timing at which the determination by the determination unit 16 is executed is not limited, but for example, the determination is executed every time an actual measurement value is calculated.

In a case where the determination unit 16 determines that the growth of the crop is delayed, the display control unit 14 outputs the handling reference information, for example, in a case where the information about the growth situation of the crop is output to the terminal device 5. As a result, the handling reference information is displayed on the display device 8 related to the terminal device 5. FIG. 13 illustrates an example of the handling reference information displayed on the display device 8. In the example of FIG. 13, weather information that greatly affects the growth of the crop is displayed.

A technique for detecting the occurrence of diseases in crops has been developed, and in a farm field to which such a technique is applied, the occurrence of diseases in crops can be detected. In such a case, for example, the growth information providing apparatus 1 can estimate that the cause of the growth delay is disease based on the information about the presence or absence of occurrence of disease. In a case where the cause of the growth delay is estimated to be a disease, an example of the handling reference information includes information including description of one or more diseases and a handling method for the disease.

Furthermore, in a case where information about a handling method for growth delay based on knowledge of an agricultural expert is accumulated in the database in advance, another example of the handling reference information includes information about a handling method based on such knowledge of an agricultural expert.

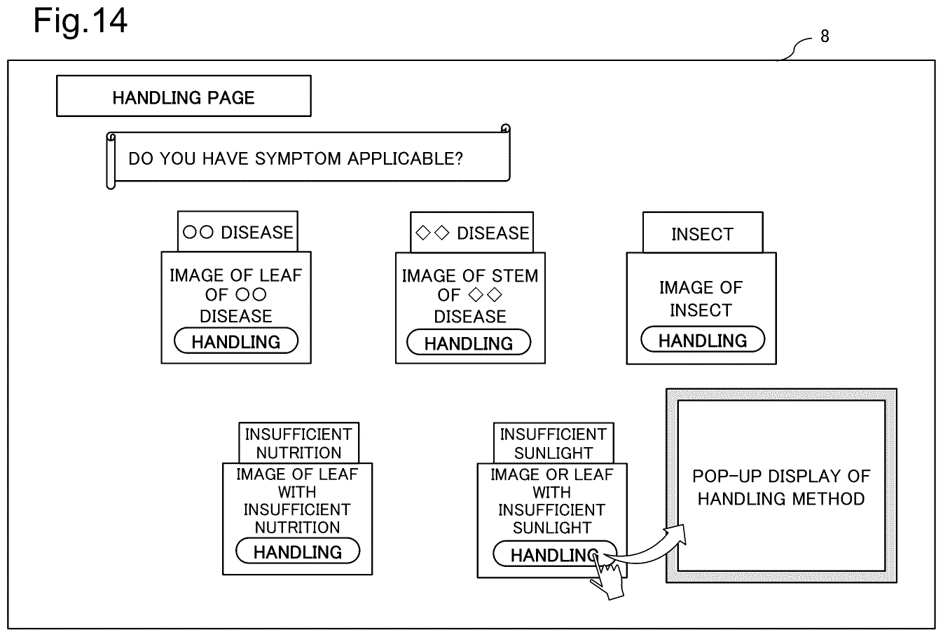

Furthermore, another example of the handling reference information includes information as illustrated in FIG. 14 that is useful when a farm field interested party identifies the cause of the delay in the growth of the crop. The handling reference information illustrated in FIG. 14 includes a description of a plurality of events that is likely to cause a delay in the growth of the crop and information about a method of handling the events.

### Other Example Embodiments

The present disclosure is not limited to the first to third example embodiments, and various example embodiments can be used. For example, the growth information providing apparatus 1 may have a configuration for providing information about irrigation control in a farm field in addition to the configuration for providing information about the growth situation of the crop as described in the first to third example embodiments. In this case, the growth information providing apparatus 1 is connected to an information source (for example, an irrigation control device (control panel of irrigation control)) 3 that provides information about irrigation control. The acquisition unit 11 acquires information about irrigation control from the information source 3. The growth information providing apparatus 1 receives a request for providing information about irrigation control from the terminal device 5, and the display control unit 14 outputs the information about the irrigation control to the terminal device 5 in response to the request. As a result, the information about the irrigation control is displayed on the display device 8 related to the terminal device 5.

In the first to third example embodiments, an actual measurement value of the NDVI that is a vegetation index indicating a crop growth situation, is calculated using information acquired from a satellite image of a farm field. Alternatively, the actual measurement value of the NDVI may be calculated by the actual measurement value calculation unit 12 using electromagnetic wave data of a specific wavelength band used for calculating the NDVI acquired from a sensor mounted on an aircraft, a drone, or the like. As described above, the information used for calculating the actual measurement value of the NDVI is not limited to the information acquired from the satellite image of the farm field. In a case where the information used for calculating the NDVI is information other than the satellite image of the farm field, the acquisition unit 11 acquires information used for calculating the actual measurement value of the NDVI from another information source 3 that outputs information used for calculating the actual measurement value of the NDVI, instead of the information source 3 that outputs the satellite image of the farm field.

Furthermore, the trial calculation unit 13 may calculate, as a reference curve, an average value of actual growth curves (a curve representing a transition of an actual measurement value of a vegetation index representing a growth situation of a crop) of a plurality of similar surrounding farm fields in the same cultivation year. The similar farm field is, for example, a farm field determined to be similar to the farm field to which information is to be provided using information about the number of elapsed days after planting, the type of crop, the variety of crop, and the soil property of the soil. That is, in a case where the difference in the number of elapsed days after planting of the crop in the farm field is within the threshold value, the type of crop is the same, the variety of crop is the same or the same lines, and the soil property type (sand, silty clay loam, etc.) is the same, it is determined that the farm field is similar. The trial calculation unit 13 calculates, as a reference curve, an average value of actual growth curves of a plurality of surrounding farm fields determined to be similar. By calculating the average value of the actual growth curves of a plurality of farm fields having substantially the same average yield in the past, the trial calculation unit 13 can calculate the reference curve according to the target yield. In a case where the reference curve is calculated in this manner, the display control unit 14 can display the reference curve on the display device 8 of the terminal device 5. The information about the actual growth curve in the surrounding farm field is acquired from a device (information source) different from the growth information providing apparatus 1. Alternatively, in a case where the growth information providing apparatus 1 calculates actual measurement values of growth situations in a plurality of mutually different farm fields by the actual measurement value calculation unit 12, and in a case where a plurality of similar farm fields as described above is included in the plurality of farm fields for which such actual measurement values are calculated, the actual measurement value of the growth situation calculated by the growth information providing apparatus 1 is used for calculating the reference curve.

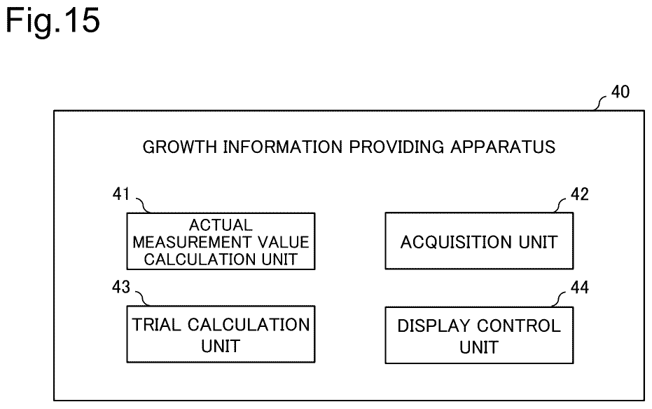

FIG. 15 is a block diagram illustrating a configuration of a growth information providing apparatus of another example embodiment according to the present disclosure. A growth information providing apparatus 40 is, for example, a computer device, and includes an actual measurement value calculation unit 41, an acquisition unit 42, a trial calculation unit 43, and a display control unit 44 as functional units implemented by executing a computer program.

The actual measurement value calculation unit 41 calculates an actual measurement value representing the growth situation of the crop in the farm field. The acquisition unit 42 acquires weather information in the farm field where the crop is planted. The trial calculation unit 43 calculates a trial calculation growth curve representing the transition of the growth situation in calculation by making a trial calculation of the transition of the growth situation of the crop toward the target yield using the environment information including the weather information after the crop is planted in the farm field and the information about the target yield of the crop. The display control unit 44 performs display control of displaying both the actual measurement value of the crop growth situation and the trial calculation growth curve.

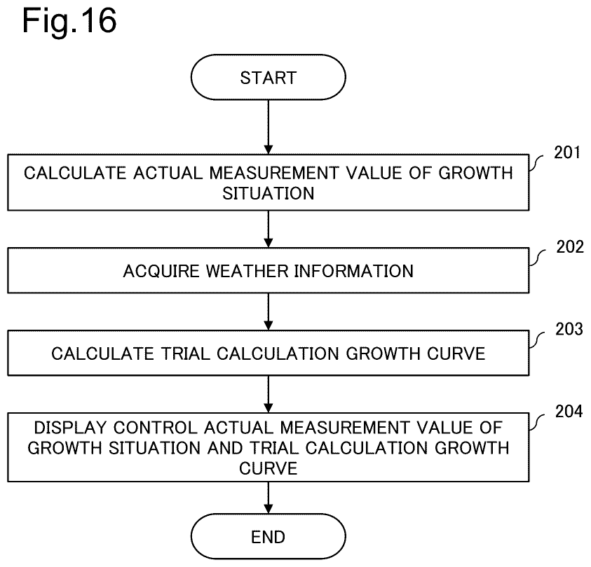

Next, an example of an operation of the growth information providing apparatus 40 will be described with reference to FIG. 16. FIG. 16 is a flowchart illustrating an example of an operation of the growth information providing apparatus 40. For example, the actual measurement value calculation unit 41 calculates an actual measurement value representing the growth situation of the crop in the farm field (step 201). The acquisition unit 42 acquires weather information in the farm field in which the crop is planted (step 202). Thereafter, the trial calculation unit 43 calculates a trial calculation growth curve representing the transition of the growth situation in calculation by making a trial calculation of the transition of the growth situation of the crop toward the target yield using the environment information including the weather information after the crop is planted in the farm field and the information about the target yield of the crop (step 203). After that, the display control unit 44 performs display control of displaying both the actual measurement value of the growth situation of the crop and the trial calculation growth curve (step 204).

As described above, the growth information providing apparatus 40 of another example embodiment calculates not only the actual measurement value of the growth situation of the crop but also the trial calculation growth curve of which the trial calculation is made using the information about the environment in which the crop has actually grown. As a result, the growth information providing apparatus 40 can display both the actual measurement value of the growth situation of the crop and the trial calculation growth curve, and such display makes it easy to determine whether the growth situation of the crop is successful or delayed. That is, the growth information providing apparatus 40 can provide information that facilitates determination as to whether the growth situation of the crop is successful or delayed.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A growth information providing apparatus comprising:
a memory configured to store instructions; and
a processor configured to execute the instructions to:
calculate an actual measurement value representing a growth situation of a crop in a farm field;
acquire weather information in the farm field in which the crop is planted;
calculate a trial calculation growth curve representing a transition of a growth situation in calculation by making a trial calculation of a transition of a growth situation of the crop toward a target yield using environment information including weather information after planting the crop in the farm field and information about the target yield of the crop; and
perform display control of displaying both the actual measurement value of the growth situation of the crop and the trial calculation growth curve.

2. The growth information providing apparatus according to claim 1, wherein the processor is configured to execute the instructions to:
calculate, as an actual measurement value representing a growth situation of a crop, a plurality of kinds of actual measurement values including an actual measurement value representing a growth situation of a leaf of the crop.

3. The growth information providing apparatus according to claim 2, wherein the processor is further configured to execute the instructions to:
detect a transition of a growth stage of a crop using a change tendency of an actual measurement value based on a transition of the actual measurement value representing a growth situation of a leaf of the crop.

4. The growth information providing apparatus according to claim 1, wherein the processor is further configured to execute the instructions to:
determine whether growth of a crop is delayed by comparing an actual measurement value with a trial calculation growth curve, and wherein in a case where the growth of the crop is delayed, the processor is configured to execute the instructions to:
perform display control of displaying handling reference information serving as a reference to handle the delay.

5. The growth information providing apparatus according to claim 1, wherein the processor is configured to execute the instructions to:
calculate a plurality of trial calculation growth curves related to a plurality of target yields different from each other, and
perform display control of displaying a trial calculation growth curve selected from among the calculated trial calculation growth curves.

6. The growth information providing apparatus according to claim 1, wherein the processor is configured to execute the instructions to:
perform display control of displaying environment information about a farm field.

7. A growth information providing method executed by a computer, the method comprising:
calculating an actual measurement value representing a growth situation of a crop in a farm field;
acquiring weather information in the farm field in which the crop is planted;
calculating a trial calculation growth curve representing a transition of a growth situation in calculation by making a trial calculation of a transition of a growth situation of the crop toward a target yield using environment information including weather information after planting the crop in the farm field and information about the target yield of the crop; and
displaying both the actual measurement value of the growth situation of the crop and the trial calculation growth curve.

8. A non-transitory computer readable medium that stores a computer program for causing a computer to execute the steps of:
calculating an actual measurement value representing a growth situation of a crop in a farm field;
acquiring weather information in the farm field in which the crop is planted;
calculating a trial calculation growth curve representing a transition of a growth situation in calculation by making a trial calculation of a transition of a growth situation of the crop toward a target yield using environment information including weather information after planting the crop in the farm field and information about the target yield of the crop; and
displaying both the actual measurement value of the growth situation of the crop and the trial calculation growth curve.
